(19) United States
(12) Patent Application Publication
(10) Pub. No.: US 2017/0306622 A1
(43) Pub. Date: Oct. 26, 2017

(54) Acoustic Performance of Timber Frame Partitions

(71) Applicant: Saint-Gobain Construction Poducts UK Limited, Coventry (GB)

(72) Inventors: Jan Rideout, Rothley (GB); Robert Evans, Coventry (GB)

(21) Appl. No.: 15/517,569

(22) PCT Filed: Oct. 9, 2015
(86) PCT No.: PCT/GB15/52968

§ 371 Date: Apr. 7, 2017

(30) Foreign Application Priority Data
Oct. 9, 2014 (GB) 1417905.5

(51) Int. Cl. E04B 2/74; C04B 28/14; E04B 1/84; E04B 2/04; E04B 2/70

(52) U.S. Cl. CPC E04B 2/7412; E04B 2/04; E04B 2/707; C04B 28/14; E04B 1/84; E04B 2002/7477

(57) ABSTRACT

A partition for a building structure comprises a support frame and a plasterboard affixed to the support frame with a plurality of screws. The plasterboard comprises a gypsum matrix having fibres embedded therein in an amount of at least 1 wt % relative to the gypsum, as well as a polymeric additive that is present in an amount of at least 1 wt % relative to the gypsum. The support frame comprises a plurality of elongate timber members and the average spacing between nearest-neighbour screws is greater than 400 mm.

### FIELD OF THE INVENTION

The present invention relates to the field of timber frame partitions that have improved acoustic performance, in particular to timber frame partitions having plasterboard cladding.

### BACKGROUND TO THE INVENTION

It is thought that timber stud partitions having gypsum board cladding exhibit worse acoustic performance that metal stud partitions with equivalent cladding.

It is desirable to improve the acoustic performance of timber stud partitions, without having a negative impact on other aspects of the performance of the partition.

### SUMMARY OF THE INVENTION

Surprisingly, it has been found that when the gypsum board used as cladding contains relatively high levels of fibre and a polymeric additive, the number of fixing screws joining the gypsum cladding to the timber frame may be reduced so as to improve the acoustic performance of the partition, while the fire resistance is maintained at acceptable levels. This result is counter-intuitive, as it had previously been thought that a reduction in the number of fixing screws would inevitably result in a significant decrease in fire resistance.

Therefore, in a first aspect, the present invention may provide a partition for a building structure, the partition comprising a support frame and at least one plasterboard affixed to the support frame by means of a plurality of screws, wherein:
the plasterboard comprises a gypsum matrix having fibres embedded therein in an amount of at least 1 wt % relative to the gypsum, the gypsum matrix further comprising a polymeric additive that is present in an amount of at least 1 wt % relative to the gypsum;;
the support frame comprises a plurality of elongate timber members; and
the average spacing between nearest-neighbour screws is greater than 400 mm.

Preferably, the average spacing between nearest-neighbour screws is greater than 500 mm, preferably greater than 550 mm.

By reducing the number of screws, the installation costs for the partition are also reduced.

Typically, at least a portion of the screws is distributed around the perimeter of the plasterboard, and engages with timber members disposed at the perimeter of the plasterboard.

In general, at least one screw is located in a central region of the plasterboard, displaced from the perimeter of the plasterboard, and engages with a timber member disposed along a central region of the plasterboard, wherein the average distance between nearest-neighbour screws disposed along the central region of the plasterboard is greater than 600 mm.

Preferably, the average distance between nearest-neighbour screws disposed along the central region of the plasterboard is greater than 800 mm, preferably greater than 1000 mm.

Preferably, the fibres are present in the gypsum matrix in an amount of at least 3 wt % relative to the gypsum, more preferably at least 5 wt %.

Preferably, the polymeric additive is present in an amount of at least 3 wt % relative to the gypsum, more preferably at least 5 wt %.

Typically, the fibres are glass fibres.

Typically, the polymeric additive is one of starch or polyvinyl acetate.

Preferably, the plasterboard is in direct contact with the support frame, that is, no adhesive is used to bond the plasterboard to the support frame. The plasterboard may comprise a gypsum core having a liner on one or both faces. In that case, the liner is typically in direct contact with the support frame.

### DETAILED DESCRIPTION

The invention will now be described by way of example with reference to the following Figures in which:

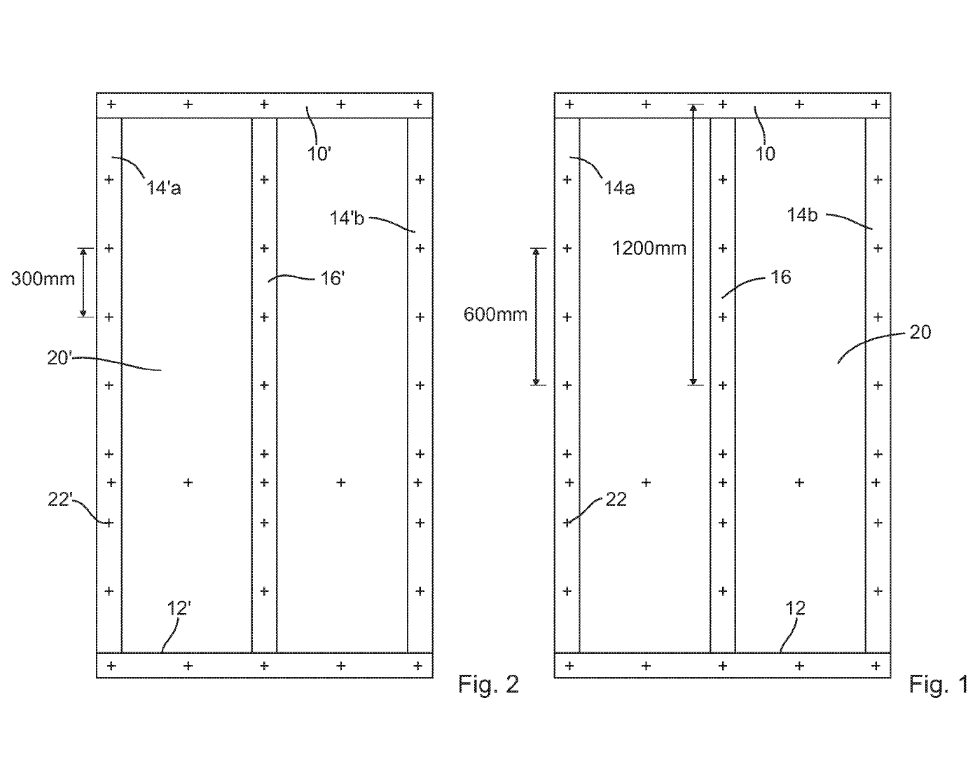

FIG. 1 shows a schematic elevation view of an embodiment of a partition according to the first aspect of the present invention. The cladding is rendered transparent to show the detail of the frame;

FIG. 2 shows a schematic elevation view of a partition according to an illustrative example of the present invention; the cladding is rendered transparent to show the detail of the frame.

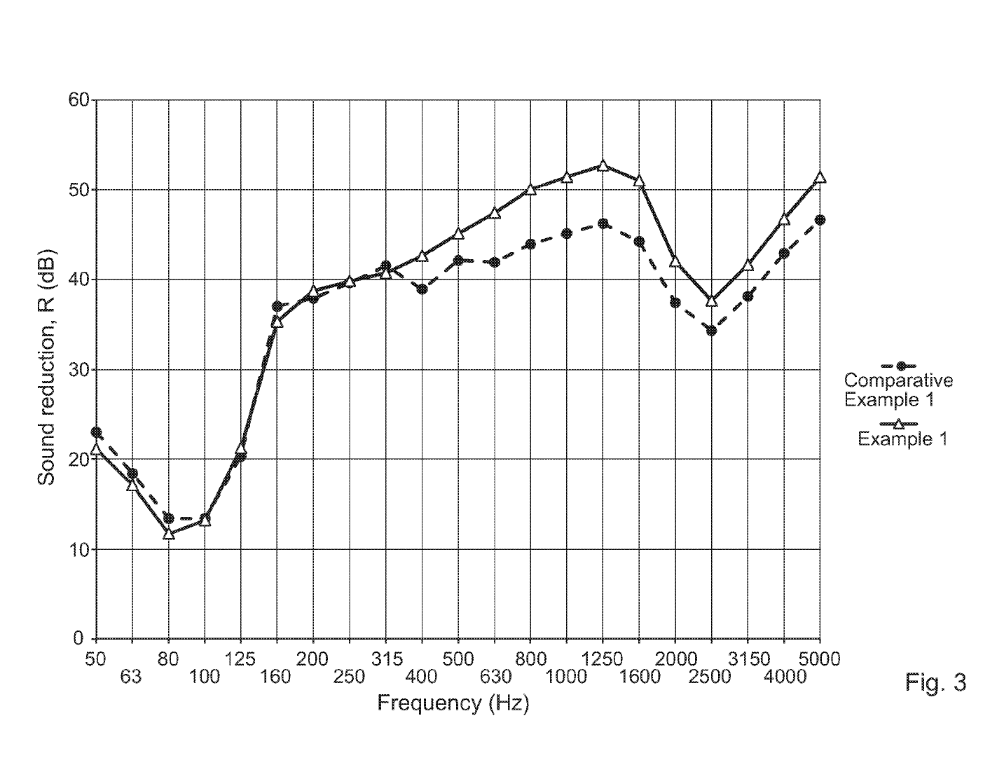

FIG. 3 is a graph showing the results of acoustic testing for Example 1 and Comparative Example 1.

### EXAMPLE 1

A test specimen was constructed from a timber frame, insulation and a gypsum plasterboard.

The timber frame consisted of 63 mm×38 mm head and base rails connected by 63 mm×38 mm timber studs extending therebetween. The distance between the head and base rails was 2400 mm, while the timber studs were spaced at 600 mm intervals. 65 mm insulation was placed within the stud cavity.

The frame was clad on each side with a single layer of boards having the following characteristics:
a gypsum core containing 3 wt % 6 mm glass fibre and 5 wt % Merifilm starch from Tate & Lyle; and
a paper liner.

The stucco slurry used to prepare the boards had a water gauge (that is, a weight ratio of water to stucco) of 0.7.

The board had a thickness of 12.5 mm and a weight of about 12 kg/m². The board dimensions were 1200 mm×2400 mm.

The boards were fixed to the frame as shown in FIG. 1. Referring to FIG. 1, the frame comprised a top rail 10 and a bottom rail 12, two lateral studs 14a,b and a central stud 16.

The board 20 is fixed to the frame by means of screws 22 that are spaced at 600 mm intervals along the top and bottom rails 10,12 and the lateral studs 14a,b, and that are spaced at 1200 mm intervals along the central stud 16.

### Comparative Example 1

A test specimen was constructed from a timber frame, insulation and a gypsum plasterboard.

The timber frame consisted of 63 mm×38 mm head and base rails connected by 63 mm×38 mm timber studs extending therebetween. The distance between the head and base rails was 2400 mm, while the timber studs were spaced at 600 mm intervals. 65 mm insulation was placed within the stud cavity.

The frame was clad on each side with a single layer of boards having the following characteristics:
a gypsum core containing 3 wt % 6 mm glass fibre and 5 wt % Merifilm starch from Tate & Lyle; and
a paper liner.

The stucco slurry used to prepare the boards had a water gauge (that is, a weight ratio of water to stucco) of 0.7.

The board had a thickness of 12.5 mm and a weight of about 12 kg/m². The board dimensions were 1200 mm×2400 mm.

The boards were fixed to the frame as shown in FIG. 2. Referring to FIG. 2, the frame comprised a top rail 10′ and a bottom rail 12′, two lateral studs 14′a,b and a central stud 16′.

The board 20′ is fixed to the frame by means of screws 22′ that are spaced at 300 mm intervals along the top and bottom rails 10′,12′ and the lateral studs 14′a,b, and that are spaced at 300 mm intervals along the central stud 16′.

### Acoustic Testing

Acoustic testing was carried out according to BS EN ISO 10140-2:2010. The results are shown in FIG. 3.

The results were processed as set out in ISO 717-1:1997, and the result of these calculations was an R_{w} value of 42 for Example 1 and an R_{w} value of 39 for Comparative Example 1.

### Fire Tests

Fire testing was carried out according to the standards BS EN 1364-1 and BS 476: part 22. The requirements of the standard were shown to be satisfied for both Example 1 and Comparative Example 1.

1. A partition for a building structure, the partition comprising a support frame and at least one plasterboard affixed to the support frame with a plurality of screws, wherein:
the plasterboard comprises a gypsum matrix having fibres embedded therein in an amount of at least 1 wt % relative to the gypsum of the gypsum matrix, the gypsum matrix further comprising a polymeric additive that is present in an amount of at least 1 wt % relative to the gypsum;
the support frame comprises a plurality of elongate timber members; and
an average spacing between nearest-neighbour screws is greater than 500 mm.

2. The partition of claim 1, wherein the average spacing between nearest-neighbour screws is greater than 550 mm.

3. (canceled)

4. The partition of claim 1, wherein the fibres are present in the gypsum matrix in an amount of at least 3 wt % relative to the gypsum.

5. The partition of claim 1, wherein the polymeric additive is present in an amount of at least 3 wt % relative to the gypsum.

6. The partition of claim 5, wherein the polymeric additive is present in an amount of at least 5 wt % relative to the gypsum.

7. The partition of claim 1, wherein the fibres are present in an amount of about 3 wt % relative to the gypsum and the polymeric additive is present in an amount of about 5 wt % relative to the gypsum.

8. The partition of claim 1, wherein the plasterboard is in direct contact with the support frame.

9. The partition of claim 1, wherein at least a portion of the screws is distributed around a perimeter of the plasterboard, and engages with timber members disposed at the perimeter of the plasterboard.

10. The partition of claim 1, wherein at least one screw is located in an inner region of the plasterboard that is displaced from a perimeter of the plasterboard, and engages with a central timber member that contacts the inner region of the plasterboard, wherein the average spacing between nearest-neighbour screws disposed along the central timber member is greater than 600 mm.

11. The partition of claim 10, wherein the average spacing between nearest-neighbour screws disposed along the central timber member is greater than 800 mm.

12. The partition of claim 11, wherein the average spacing between nearest-neighbour screws disposed along the central timber member is greater than 1000 mm.
